(19) United States
(12) Patent Application Publication
(10) Pub. No.: US 2025/0162375 A1
(43) Pub. Date: May 22, 2025

(54) STABILIZER BUSHING

(71) Applicants: SUMITOMO RIKO COMPANY LIMITED, Komaki-shi (JP); TOYOTA JIDOSHA KABUSHIKI KAISHA, Toyota-shi (JP)

(72) Inventors: Kazuki HOTTA, Komaki-shi (JP); Mizuki IMURA, Anjyo-shi (JP)

(73) Assignees: SUMITOMO RIKO COMPANY LIMITED, Komaki-shi (JP); TOYOTA JIDOSHA KABUSHIKI KAISHA, Toyota-shi (JP)

(21) Appl. No.: 18/922,689

(22) Filed: Oct. 22, 2024

(30) Foreign Application Priority Data
Nov. 16, 2023 (JP) 2023-195478

(51) Int. Cl. B60G 21/055

(52) U.S. Cl. CPC B60G 21/0551; B60G 2204/122; B60G 2204/4104; B60G 2204/4307; B60G 2206/73

(57) ABSTRACT

A stabilizer bushing including a bushing body formed of a tubular rubber elastic body and including a sliding liner disposed on an inner surface of its inner hole. A stabilizer bar is inserted through the inner hole without being bonded thereto and a bracket is mounted onto an outer surface of the bushing body to attach the bushing body to a vehicle body via the bracket. Two rigid intermediate members are fastened to the bushing body on opposite sides of the inner hole to face each other, and include respective first and second facing plate parts protruding radially outward from opposite ends. A slit circumferentially dividing the bushing body is formed between the first facing plate parts. A cut extending radially outward from the inner hole to a radially middle part of the bushing body is formed between the second facing plate parts.

### INCORPORATED BY REFERENCE

The disclosure of Japanese Patent Application No. 2023-195478 filed on Nov. 16, 2023 including the specification, drawings and abstract is incorporated herein by reference in its entirety.

### BACKGROUND ART

### 1. Technical Field

The present disclosure relates to a stabilizer bushing used for attaching a stabilizer bar to a vehicle for the purpose of stabilizing an attitude of the vehicle and the like.

### 2. Description of the Related Art

Conventionally, a stabilizer bushing has been known to be used for attaching a stabilizer bar to a vehicle. For example, as shown in U.S. Publication No. US 2011/0291377 A1, a stabilizer bushing includes a tubular bushing body formed of a rubber elastic material, etc. A stabilizer bar is inserted through an inner hole penetrating the bushing body and slidably attached without being bonded thereto, while the outer peripheral surface of the bushing body is attached to the vehicle body by a bracket.

Meanwhile, the stabilizer bushing of US 2011/0291377 A1 includes a pair of partition members, and the partition members partition the bushing body into the radially inner side and the radially outer side. This prevents a low-friction sliding liner provided on the inner surface of the inner hole of the bushing body from being biased or wrinkled, while reliably obtaining the required characteristics of the bushing body.

Besides, regarding the partition members of the stabilizer bushing of US 2011/0291377 A1, the circumferentially opposite ends comprise bending parts and exposed parts protruding outward in the left-right direction. The bending parts and the exposed parts of the pair of partition members face each other in close proximity, and in the structure shown in FIG. 1, etc., the facing bending parts and the facing exposed parts of those pair of partition members are continuously connected by the bushing body.

### SUMMARY

The stabilizer bushing of US 2011/0291377 A1 has a slit formed in the portion of the bushing body connecting the facing bending parts and the facing exposed parts of the pair of partition members. The bushing body can be circumferentially opened at the slit to insert the stabilizer bar through the slit into the inner hole. The slit is provided between the first circumferential ends of the partition members, and the second circumferential ends are connected by the bushing body.

However, when opening the slit, the bushing body undergoes compressive deformation and tensile deformation between the second circumferential ends of the partition members where the slit is not provided, so that large force is required to open the slit, which may adversely affect the workability of the stabilizer bar assembly. In particular, in the structure of US 2011/0291377 A1, since the partition members are provided with the bending parts and the exposed parts at the circumferential ends, the compression and tension of the bushing body between the facing bending parts and between the facing exposed parts when opening the slit may be greater, and thus larger force may conceivably be required to open the slit.

It is therefore one object of the present disclosure to provide a stabilizer bushing of novel structure which is able to allow the slit of the bushing body to be opened with relatively small force and enable the stabilizer bar to be easily inserted into the inner hole of the bushing body.

Hereinafter, preferred embodiments for grasping the present disclosure will be described. However, each preferred embodiment described below is exemplary and can be appropriately combined with each other. Besides, a plurality of elements described in each preferred embodiment can be recognized and adopted as independently as possible, or can also be appropriately combined with any element described in other preferred embodiments. By so doing, in the present disclosure, various other preferred embodiments can be realized without being limited to those described below.

A first preferred embodiment provides a stabilizer bushing comprising: a bushing body formed of a tubular rubber elastic body with an inner hole and including a low-friction sliding liner disposed on an inner circumferential surface of the inner hole, the bushing body being configured to receive a stabilizer bar inserted through the inner hole without being bonded thereto while an outer peripheral surface of the bushing body being configured to receive a bracket such that the bushing body is attached to a vehicle body via the bracket; two intermediate members having rigidity and fastened to the bushing body on opposite sides of the inner hole to be arranged facing each other, the two intermediate members including respective first facing plate parts and respective second facing plate parts protruding radially outward from opposite ends in a circumferential direction of the bushing body; a slit dividing the bushing body in the circumferential direction, the slit being formed between the first facing plate parts facing each other; and a cut extending radially outward from the inner hole to a radially middle part of the bushing body, the cut being formed between the second facing plate parts facing each other.

According to the stabilizer bushing structured following the present preferred embodiment, the slit is provided between the first facing plate parts facing each other, and a cut is provided between the second facing plate parts facing each other. Thus, when the slit is opened and the stabilizer bar is inserted into the inner hole of the bushing body, the bushing body is less likely to be restrained by the second facing plate parts, and the slit can be opened with less force.

A second preferred embodiment provides the stabilizer bushing according to the first preferred embodiment, wherein an end of the cut opposite the inner hole is located in the same position or outside in a radial direction with respect to distal ends of the second facing plate parts.

According to the stabilizer bushing structured following the present preferred embodiment, even in the case where the protruding length dimension of the second facing plate part is large, the spring during opening the slit is sufficiently reduced by the cut.

A third preferred embodiment provides the stabilizer bushing according to the first or second preferred embodiment, wherein at least in a state where the bushing body is mounted onto a vehicle, inner surfaces of the cut are configured to be in contact with each other.

According to the stabilizer bushing structured following the present preferred embodiment, occurrence of noise, abrasion of the bushing body, and the like due to entry of debris into the cut in a mounted state onto the vehicle will be prevented.

A fourth preferred embodiment provides the stabilizer bushing according to any one of the first through third preferred embodiments, wherein a distance between the second facing plate parts is larger than a radius of the inner hole.

In the stabilizer bushing structured following the present preferred embodiment, since the stabilizer bar is inserted through the inner hole of the bushing body without being bonded thereto, the intermediate member can be arranged in a position remote from the inner hole in comparison with the case where the stabilizer bar is inserted through the bushing body in a bonded state. Therefore, according to the present preferred embodiment, a long free length of the bushing body between the second facing plate parts can be reliably obtained, thereby reducing the high spring of the bushing body between the second facing plate parts when the slit is opened.

According to the present disclosure, the stabilizer bushing is able to allow the slit of the bushing body to be opened with relatively small force and enable the stabilizer bar to be easily inserted into the inner hole of the bushing body.

### BRIEF DESCRIPTION OF THE DRAWINGS

The foregoing and/or other objects, features and advantages of the disclosure will become more apparent from the following description of practical embodiments with reference to the accompanying drawings in which like reference numerals designate like elements and wherein:

FIG. 1 is a perspective view of a stabilizer bushing according to a first practical embodiment of the present disclosure;

FIG. 2 is a front view of the stabilizer bushing shown in FIG. 1;

FIG. 3 is a plan view of the stabilizer bushing shown in FIG. 1;

FIG. 4 is a cross sectional view taken along line 4-4 of FIG. 3;

FIG. 5 is a perspective view of intermediate members constituting the stabilizer bushing shown in FIG. 1;

FIG. 6 is a cross sectional view showing the stabilizer bushing of FIG. 1 in a mounted state onto a vehicle; and

FIG. 7 is a cross sectional view showing the stabilizer bushing of FIG. 1 in a process of being mounted onto a stabilizer bar.

### DETAILED DESCRIPTION

Hereinafter, a practical embodiment of the present disclosure will be described with reference to the drawings.

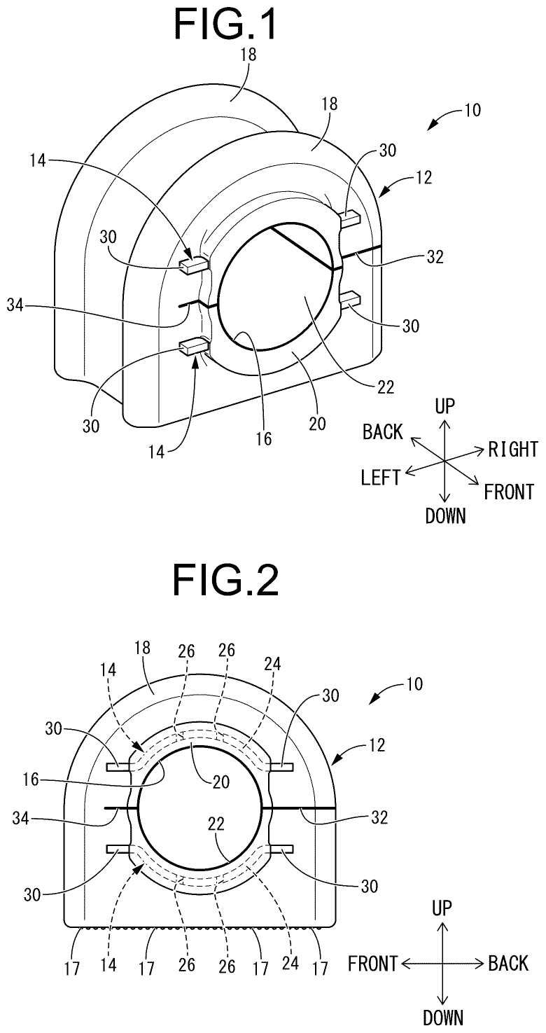

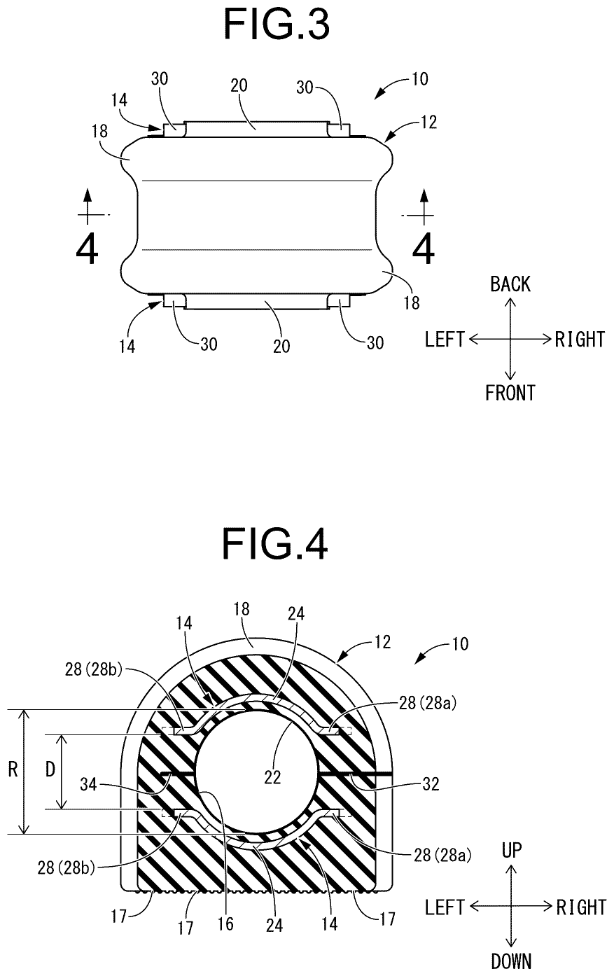

FIGS. 1 to 4 show a stabilizer bushing 10 according to a first practical embodiment of the present disclosure. The stabilizer bushing 10 has a structure in which a pair of intermediate members 14, 14 are fastened to a bushing body 12. In the following description, as a general rule, the vertical direction refers to the vertical direction in FIG. 2, the left-right direction refers to the left-right direction in FIG. 2, and the front-back direction refers to the vertical direction in FIG. 3. Each direction of the stabilizer bushing 10 used in the present practical embodiment for explanation does not necessarily correspond to each direction of the vehicle onto which the stabilizer bushing 10 is mounted.

The bushing body 12 is formed of a rubber elastic body, and has an approximately tubular shape overall. An inner hole 16 perforates the bushing body 12 in the axial direction (the front-back direction). In the bushing body 12, the outer peripheral surface portion located on the upper side in FIG. 4 (hereinafter referred to as the “upper surface”) comprises an approximately half cylindrical surface. Besides, two outer peripheral surface portions located on the left and right sides in FIG. 4 (hereinafter referred to as the “side surfaces”), and the outer peripheral surface portion located on the lower side in FIG. 4 (hereinafter referred to as the “lower surface”) each comprise a rectangular flat surface. A multitude of hemispherical cushion projections 17 protrude from the lower surface of the bushing body 12, and owing to the cushion projections 17, noise reduction or the like will be achieved in a mounted state onto the vehicle described later.

A pair of ridges 18, 18 are integrally formed with the outer peripheral surface of the bushing body 12. The ridges 18 protrude radially outward at axially opposite end portions of the bushing body 12, and extend in the circumferential direction in a portion of the bushing body 12 excluding the lower surface.

An annular protrusion 20 is integrally formed with each axial end face of the bushing body 12. The annular protrusion 20 is annularly provided at the periphery of the opening of the inner hole 16 so as to surround the opening of the inner hole 16, and protrudes axially outward. The protruding distal end face of the annular protrusion 20 is a plane that is approximately orthogonal to the front-back direction, and the protrusion height dimension is approximately constant about the entire circumference. The annular protrusion 20 is radially narrower in the left and right side portions than in the upper and lower side portions.

A low-friction sliding liner 22 is disposed on the inner circumferential surface of the bushing body 12. The sliding liner 22 is a cloth or a sheet having surface lubricity, and may suitably adopt, for example, a fluororesin fiber cloth that is mainly composed of fluororesin fibers, a knitted fabric made of polyamide fibers, and the like. The sliding liner 22 may be fastened to the inner circumferential surface of the bushing body 12 after molding by bonding or the like, but the manufacturing process can be simplified by integrally fastening the sliding liner 22 to the inner circumferential surface of the bushing body 12 during molding of the bushing body 12.

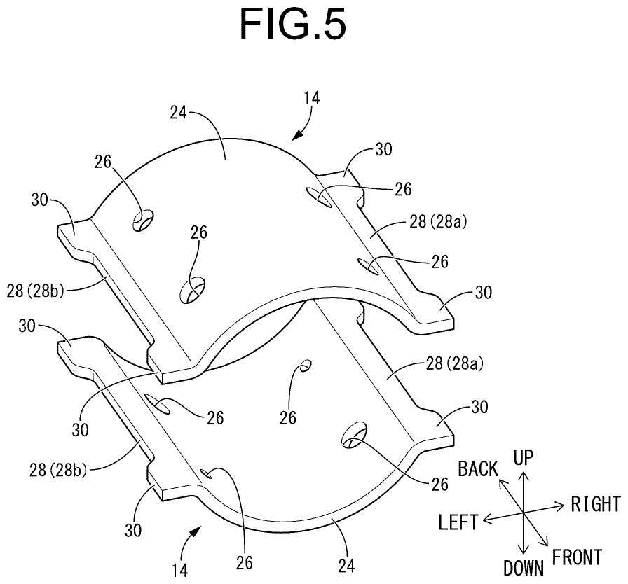

As shown in FIG. 5, each intermediate member 14 has a plate shape, and is a rigid member formed of metal, fiber-reinforced synthetic resin, or the like, for example. In the intermediate member 14, the middle portion in the left-right direction comprises a curving plate part 24 curving in an arc shape. The curving plate part 24 is perforated by communication holes 26 in the thickness direction, allowing the material forming the bushing body 12 to flow through the communication holes 26 between the radially inner side and the radially outer side of the intermediate member 14 when the bushing body 12 is molded.

Additionally, in the intermediate member 14, the opposite ends in the left-right direction comprise facing plate parts 28, 28 protruding outward in the left-right direction from the left and right ends of the curving plate part 24. Each facing plate part 28 has a flat plate shape extending approximately orthogonally to the vertical direction, and is provided continuously across the entire length of the intermediate member 14 in the front-back direction. The opposite end portions of the facing plate part 28 in the front-back direction comprise protruding parts 30, 30 that protrude outward in the left-right direction further than the middle portion does.

As shown in FIG. 4, the pair of intermediate members 14, 14 are fastened to the upper and lower opposite sides of the inner hole 16 in the bushing body 12, and are arranged facing each other in the vertical direction. The intermediate member 14 is fastened to the bushing body 12 in an embedded state, and as shown in FIGS. 1 to 3, is exposed to the outside from the bushing body 12 at the protruding parts 30, 30 of each facing plate part 28. The pair of intermediate members 14, 14 in the present practical embodiment are rotationally symmetrical 180 degrees about the center axis of the bushing body 12, and can be formed of common parts.

As shown in FIG. 4, each intermediate member 14 is arranged closer to the inner hole 16 than the outer peripheral surface of the bushing body 12 in the vertical direction. The facing plate parts 28, 28 of the intermediate member 14 protrude outward in the left-right direction with respect to the inner hole 16. In the following description, the right-side facing plate parts 28, 28 in the pair of intermediate members 14, 14 are referred to as the “first facing plate parts 28a, 28a”, while the left-side facing plate parts 28, 28 in the pair of intermediate members 14, 14 are referred to as the “second facing plate parts 28b, 28b”. Accordingly, in the pair of intermediate members 14, 14, the first facing plate parts 28a, 28a face each other in the vertical direction on the right side of the inner hole 16, while the second facing plate parts 28b, 28b face each other in the vertical direction on the left side of the inner hole 16. A portion of the bushing body 12 is interposed between the first facing plate parts 28a, 28a as well as between the second facing plate parts 28b, 28b.

The distance D between the second facing plate parts 28b, 28b in the vertical direction is suitably a half or more of the diameter R of the inner hole 16, and more suitably 70% or more of the diameter R of the inner hole 16. In the present practical embodiment, the distance between the first facing plate parts 28a, 28a and the distance between the second facing plate parts 28b, 28b are set to be approximately the same D as each other, but may be different from each other, for example.

A slit 32 is formed in the portion of the bushing body 12 located between the first facing plate parts 28a, 28a. The slit 32 extends rightward from the inner hole 16 of the bushing body 12 and reaches the outer peripheral surface (the right side surface) of the bushing body 12. With this configuration, the bushing body 12 is divided in the circumferential direction at the portion where the slit 32 is formed. By applying force to open the slit 32, the inner hole 16 will communicate with the outer peripheral space through the slit 32.

A cut 34 is formed in the portion of the bushing body 12 located between the second facing plate parts 28b, 28b. The cut 34 extends leftward from the inner hole 16 of the bushing body 12 to the radially middle part of the bushing body 12, without reaching the outer peripheral surface (the left side surface) of the bushing body 12. Thus, the bushing body 12 is continuous in the circumferential direction on the left side of the cut 34. The cut 34 may be groove-shaped with a certain width dimension in the vertical direction, but in the present practical embodiment, the inner surfaces of the cut 34 are in contact with each other in the isolated state of the stabilizer bushing 10 shown in FIG. 4, and the vertical width dimension is 0. Although the left-right length dimension of the cut 34 is not particularly limited, the cut 34 suitably reaches the same position or outside in the left-right direction, which is the radial direction in which the cut 34 extends, with respect to the protruding distal ends of the middle portion in the second facing plate parts 28b, 28b off each protruding part 30. More suitably, the cut 34 reaches the same position or outside in the left-right direction with respect to the protruding distal end of each protruding part 30 in the second facing plate parts 28b, 28b.

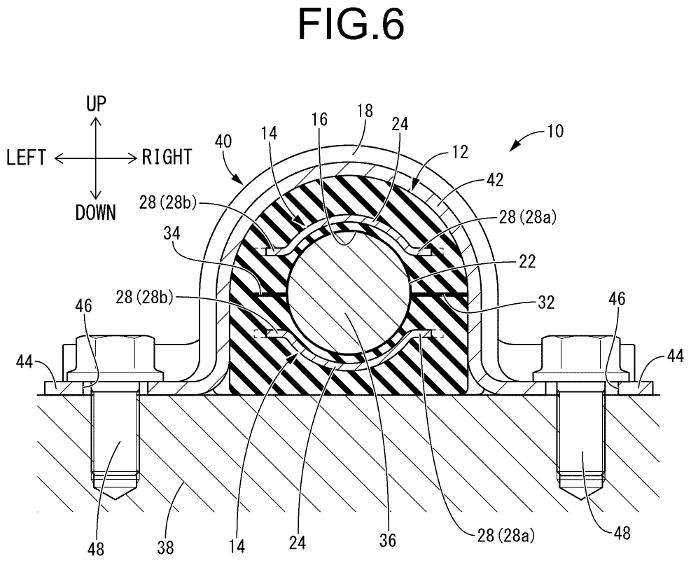

As shown in FIG. 6, the stabilizer bushing 10 of the above construction is mounted and used in a vehicle. That is, the stabilizer bushing 10 is configured to be interposed between a stabilizer bar 36 and a vehicle body 38 by the stabilizer bar 36 being inserted through the inner hole 16 of the bushing body 12 without being bonded thereto while the outer peripheral surface of the bushing body 12 being overlapped with the vehicle body 38 and a bracket 40 fixed to the vehicle body 38. The bracket 40 has a band plate shape overall, and includes a groove-shaped bushing mounting part 42 to be overlapped with the upper surface and the opposite side surfaces of the outer peripheral surface of the bushing body 12, and attachment pieces 44, 44 protruding outward in the left-right direction from the opposite ends of the bushing mounting part 42. The bracket 40 is fixed to the vehicle body 38 by bolts 48 that are inserted through bolt holes 46 penetrating the respective attachment pieces 44, and the bushing body 12 is held between the bushing mounting part 42 of the bracket 40 and the vehicle body 38.

The radially inner portion of the bushing body 12 is restrained by the curving plate parts 24, 24 of the pair of intermediate members 14, 14, so as to be stably held in contact with the stabilizer bar 36. In the present practical embodiment, the curving plate parts 24, 24 of the intermediate members 14, 14 are arranged to be shifted to the radially inner side of the bushing body 12. Thus, the radially inner portion of the bushing body 12 is stably held in contact with the stabilizer bar 36 even during vibration input in the vertical direction, for example.

The stabilizer bar 36 is inserted through the inner hole 16 of the bushing body 12 without being bonded thereto, and is allowed to undergo torsional displacement within the inner hole 16. In particular, the sliding liner 22 provided at the radially inner end of the bushing body 12 reduces the frictional resistance acting on the stabilizer bar 36 during its torsional displacement, which facilitates allowing torsional displacement of the stabilizer bar 36.

There is no need to bond the inner circumferential surface of the bushing body 12 to the stabilizer bar 36, and there is no requirement to limit the amount of deformation of the inner circumferential surface of the bushing body 12 in such bonding process. Thus, each circumferential length of the pair of intermediate members 14, 14 can be sufficiently shorter than a half of a circumference of the bushing body 12. With this configuration, the distance between the second facing plate parts 28b, 28b is set comparatively large, thereby achieving reduction in spring of the bushing body 12 located between the second facing plate parts 28b, 28b. In the present practical embodiment, the distance D between the second facing plate parts 28b, 28b is a half or more of the diameter R of the inner hole 16, thereby ensuring a large free length of the bushing body 12 between the second facing plate parts 28b, 28b.

The stabilizer bushing 10 mounted onto the vehicle is subjected to a primary vibration load in the vertical direction. The opposite ends of each intermediate member 14 fastened to the bushing body 12 comprise the facing plate parts 28 protruding outward in the left-right direction, and the protruding distal ends of the facing plate parts 28 are located outside in the left-right direction with respect to the inner holes 16. With this arrangement, the edge of the tip end of the intermediate member 14 is less likely to be pressed strongly against the bushing body 12 during vertical vibration input, thereby preventing the bushing body 12 from being damaged by being pressed against the edge of the intermediate member 14. In particular, the facing plate part 28 has a flat plate shape that extends approximately orthogonally to the vertical direction, which is the primary vibration input direction, so that the pressing of the edge against the bushing body 12 is further reduced.

In a state where the stabilizer bushing 10 is mounted onto the vehicle, in the slit 32 of the bushing body 12, the inner surfaces are in contact with each other, thereby preventing entry of debris. In addition, in the state where the stabilizer bushing 10 is mounted onto the vehicle, in the cut 34 of the bushing body 12, the inner surfaces are in contact with each other, thereby preventing entry of debris. In the present practical embodiment in particular, in the mounted state onto the vehicle, the bushing body 12 is compressed in the vertical direction between the bracket 40 and the vehicle body 38. Thus, the inner surfaces of the slit 32 and the inner surfaces of the cut 34 are in close contact with each other, thereby preventing entry of debris more effectively.

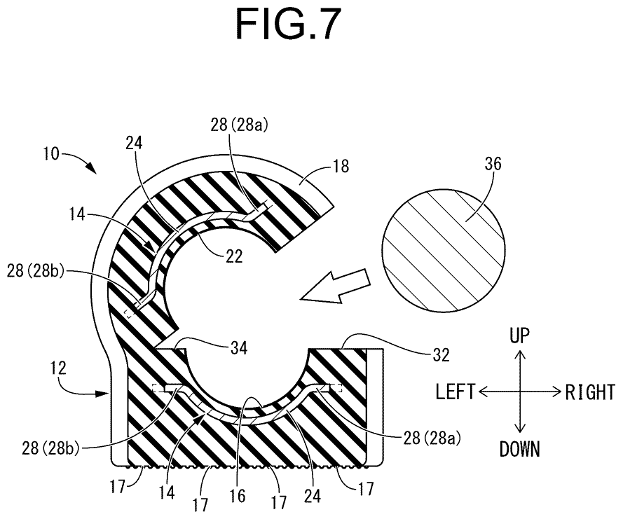

Meanwhile, as shown in FIG. 7, the stabilizer bar 36 is inserted into the inner hole 16 of the bushing body 12 through the slit 32. That is, by exerting force in the direction of mutual separation on the upper and lower portions of the slit 32 in the bushing body 12, the slit 32 is opened as shown in FIG. 7, thereby allowing the stabilizer bar 36 to be inserted into the inner hole 16 through the slit 32.

Here, the stabilizer bushing 10 has the cut 34 formed between the second facing plate parts 28b, 28b in the bushing body 12, which facilitates opening of the slit 32. That is, as shown in FIG. 7, when the slit 32 between the first facing plate parts 28a, 28a is opened by the action of external force, the cut 34 is configured to be opened between the second facing plate parts 28b, 28b. This reduces the difficulty in opening the slit 32 due to the high spring of the bushing body 12 between the second facing plate parts 28b, 28b, and allows the stabilizer bar 36 to be inserted into the inner hole 16 by opening the slit 32 with less force.

In particular, the first and second facing plate parts 28a, 28b are provided in each of the pair of intermediate members 14, 14. In such a structure, when opening the slit 32 formed between the first facing plate parts 28a, 28a, the bushing body 12 is tensed and/or compressed between the second facing plate parts 28b, 28b, and the spring constant at the said region is likely to increase. As a result, the resistance to opening the slit 32 increases, and greater force is required to open the slit 32. However, in the stabilizer bushing 10 of the present practical embodiment, the cut 34 is formed in the region of the bushing body 12 located between the second facing plate parts 28b, 28b, so that the increase of the spring of the bushing body 12 between the second facing plate parts 28b, 28b is suppressed when opening the slit 32. Thus, even if the intermediate member 14 including the first and second facing plate parts 28a, 28b is adopted, the slit 32 can be opened with relatively small force.

The left end of the cut 34 is located at approximately the same position or further to the left side with respect to the left end of the second facing plate part 28b. Therefore, the facing surfaces of the second facing plate parts 28b, 28b are not continuously connected by of the bushing body 12, but a part of the bushing body 12 is divided by the cut 34. As a result, when opening the slit 32, high spring of the bushing body 12 between the second facing plate parts 28b, 28b is prevented, and the slit 32 can be opened with less force. In the present practical embodiment in particular, the left end of the cut 34 is located at approximately the same position or further to the left side with respect to the protruding parts 30, 30 of the second facing plate parts 28b, 28b. Thus, tension and/or compression of the bushing body 12 between the protruding parts 30, 30 is also avoided, and the slit 32 is more easily opened.

A practical embodiment of the present disclosure has been described in detail above, but the present disclosure is not limited to those specific descriptions. For example, the facing plate part 28 need not necessarily include the protruding parts 30, 30. For example, the protruding dimension from the curving plate part 24 may be approximately constant in the front-back direction, or the facing plate part 28 may protrude outward in the left-right direction further in the middle portion than in the opposite ends in the front-back direction.

The outer peripheral end of the cut 34 need not necessarily reach outside with respect to the entire second facing plate part 28b in the vertical projection (the projection in the direction orthogonal to the radial direction in which the cut 34 extends). For example, in the preceding practical embodiment, the left end of the cut 34 may be located on the right side with respect to the left end of the protruding parts 30, 30 of the second facing plate part 28b. Besides, whereas it is desirable that the cut 34 extend at least partly to the outside with respect to the second facing plate part 28b, the entire cut 34 may be located between the second facing plate parts 28b, 28b, for example. Additionally, the cut 34 can extend radially outward further than the protruding parts 30, 30 of the second facing plate part 28b. Moreover, the depth of the cut 34 (the length from the inner hole 16 to the radial outside) may vary in the axial direction of the bushing body 12.

The cut 34 may be groove-shaped with its inner surfaces spaced apart from each other in the isolated state of the stabilizer bushing 10. The inner surfaces of the cut 34 may be either in contact or separated throughout, or may be partially in contact/separated. When the stabilizer bushing 10 is in a mounted state onto the vehicle in which the stabilizer bushing 10 is compressed by the tightening force applied from the outer peripheral surface by the bracket 40 and the vehicle body 38, it is desirable that the inner surfaces of the cut 34 be in contact with each other. However, the inner surfaces may be spaced apart from each other in the mounted state onto the vehicle.

The cut 34 formed between the second facing plate parts 28b, 28b and the slit 32 in the bushing body 12 can be mold-formed during the molding of the bushing body 12. However, for example, after the bushing body 12 is molded with a continuous tubular form about the entire circumference, the cut 34 or the slit 32 may be formed by a separate process such as cutting the bushing body 12 with a cutter.

The bushing body 12 is not limited to a shape with its side surfaces and the lower surface being flat, but may have a round tubular shape, for example.

The stabilizer bushing 10 may be used, for example, by being mounted onto a vehicle in an orientation rotated 90 degrees or in an orientation rotated 180 degrees from that shown in FIG. 6 of the preceding practical embodiment. That is, the direction of mounting of the stabilizer bushing 10 onto the vehicle is not limited but is set appropriately.

What is claimed is:

1. A stabilizer bushing comprising:
a bushing body formed of a tubular rubber elastic body with an inner hole and including a low-friction sliding liner disposed on an inner circumferential surface of the inner hole, the bushing body being configured to receive a stabilizer bar inserted through the inner hole without being bonded thereto while an outer peripheral surface of the bushing body being configured to receive a bracket such that the bushing body is attached to a vehicle body via the bracket;
two intermediate members having rigidity and fastened to the bushing body on opposite sides of the inner hole to be arranged facing each other, the two intermediate members including respective first facing plate parts and respective second facing plate parts protruding radially outward from opposite ends in a circumferential direction of the bushing body;
a slit dividing the bushing body in the circumferential direction, the slit being formed between the first facing plate parts facing each other; and
a cut extending radially outward from the inner hole to a radially middle part of the bushing body, the cut being formed between the second facing plate parts facing each other.

2. The stabilizer bushing according to claim 1, wherein an end of the cut opposite the inner hole is located at the same position or outside in a radial direction with respect to distal ends of the second facing plate parts.

3. The stabilizer bushing according to claim 1, wherein at least in a state where the bushing body is mounted onto a vehicle, inner surfaces of the cut are configured to be in contact with each other.

4. The stabilizer bushing according to claim 1, wherein a distance between the second facing plate parts is larger than a radius of the inner hole.
